(19) United States
(12) Patent Application Publication
(10) Pub. No.: US 2026/0248300 A1
(43) Pub. Date: Aug. 27, 2026

(54) INFANT CARRIER

(71) Applicant: Dorel Juvenile Group, Inc., Foxboro, MA (US)

(72) Inventor: Conor Newton DAVIES, Foxboro, MA (US)

(21) Appl. No.: 19/545,535

(22) Filed: Feb. 20, 2026

Related U.S. Application Data
(60) Provisional application No. 63/761,273, filed on Feb. 21, 2025.

(51) Int. Cl. A47D 13/02; B60N 2/28

(52) U.S. Cl. CPC A47D 13/027; A47D 13/025; B60N 2/2821; B60N 2/2845

(57) ABSTRACT

An infant carrier includes a seat shell formed to include a child-receiving space configured to hold a child and a carry handle coupled to an exterior surface of the seat shell outside of the child-receiving space. The carry handle includes a u-shaped hand grip arranged to extend over the child-receiving space and adapted to be engaged by a caregiver to carry the infant carrier, a first handle mount coupled to the exterior surface on a first lateral side of the seat shell, and a second handle mount coupled to the exterior surface on an opposite second lateral side of the seat shell.

### PRIORITY CLAIM

This application claims priority under 35 U.S.C. § 119(e) to U.S. Provisional Patent Application No. 63/761,273, filed February 21, 2025, which is expressly incorporated by reference herein in its entirety.

### BACKGROUND

The present disclosure relates to a child safety device, and particularly to a child restraint. More particularly, the present disclosure relates to an infant carrier.

### SUMMARY

According to the present disclosure, an infant carrier includes a seat shell formed to include a child-receiving space configured to hold a child and a carry handle coupled to an exterior surface of the seat shell outside of the child-receiving space. The carry handle includes a u-shaped hand grip arranged to extend over the child-receiving space and adapted to be engaged by a caregiver to carry the infant carrier, a first handle mount coupled to the exterior surface on a first lateral side of the seat shell, and a second handle mount coupled to the exterior surface on an opposite second lateral side of the seat shell.

In illustrative embodiments, the first and second handle mounts each include a mount body and a finger grip. The mount body is coupled to the seat shell for pivotable movement about a pivot axis. The finger grip is coupled to a lower end of the mount body and faces toward the exterior surface of the seat shell. The finger grip is spaced apart from the exterior surface of the seat shell and is configured to receive finger tips of a user to aid in carrying the infant carrier.

In illustrative embodiments, the first handle mount and the second handle mount each include an outward-facing surface, an inward-facing surface, a downward-facing surface, and a finger-receiving surface. The outward-facing surface faces away from the child-receiving space. The inward-facing surface faces toward the child receiving space and interfaces with the exterior surface of the seat shell. The downward-facing surface is coupled to a lower end of the outward-facing surface and faces away from the outward-facing surface and the inward-facing surface. The finger-receiving surface is coupled to a lower end of the inward-facing surface and is spaced apart from the exterior surface of the seat shell to provide a finger-receiving space between the finger-receiving surface and the exterior surface of the seat shell so that fingers of the caregiver can be received in the finger-receiving space to engage with the finger-receiving surface while the caregiver is carrying the infant carrier.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of an infant carrier being held by a caregiver using a woven holding technique or position, showing the infant carrier including a seat shell and a carry handle coupled to the seat shell, the carry handle including a u-shaped hand grip, a first handle mount coupled to a first lateral side of the seat shell, and a second handle mount coupled to a second lateral side of the seat shell;

FIG. 2 is a front plan view of the first handle mount attached to the seat shell showing the handle mount including a mount body coupled to the u-shaped hand grip and a finger grip coupled to a lower end of the mount body and at least partially spaced apart from an exterior surface of the seat shell to provide a finger-receiving space therebetween to aid the caregiver in carrying the infant carrier using the woven holding technique;

FIG. 3 is a front plan view showing the caregiver’s hand gripping the first handle mount and fingers of the caregiver extending into the finger-receiving space to engage with a finger-receiving surface of the finger grip;

FIG. 4 is an enlarged perspective view of a portion of the carry handle showing the first handle mount including an outward-facing surface having an upper segment and a lower segment to provide the handle mount with a geometry that increases comfort for the caregiver when carrying the infant carrier using the woven holding technique;

FIG. 5 is an enlarged perspective view of a portion of the carry handle showing the first handle mount further including an inward-facing surface coupled to an upper end of the finger-receiving surface and showing the finger grip formed to include a tip to provide a first finger-receiving region and a second finger-receiving region separated by the tip;

FIG. 6 is a perspective view of the carry handle with portions of the carry handle shown in dashed lines to highlight the first handle mount;

FIG. 7 is a front view of the carry handle with portions of the carry handle shown in dashed lines to highlight the first handle mount;

FIG. 8 is a rear view of the carry handle with portions of the carry handle shown in dashed lines to highlight the first handle mount;

FIG. 9 is a first side view of the carry handle with portions of the carry handle shown in dashed lines to highlight the first handle mount;

FIG. 10 is a cross section taken along line 10-10 in FIG. 7 with portions of the carry handle shown in dashed lines to highlight the first handle mount;

FIG. 11 is a top plan view of the carry handle with portions of the carry handle shown in dashed lines to highlight the first handle mount;

FIG. 12 is a bottom plan view of the carry handle with portions of the carry handle shown in dashed lines to highlight the first handle mount;

FIG. 13 is a perspective view of a second embodiment of an infant carrier being held by a caregiver using a woven holding technique or position, showing the infant carrier including a seat shell and a carry handle coupled to the seat shell, the carry handle including a u-shaped hand grip, a first handle mount coupled to a first lateral side of the seat shell, and a second handle mount coupled to a second lateral side of the seat shell;

FIG. 14 is a front plan view of the first handle mount of FIG. 13 attached to the seat shell showing the handle mount including a mount body coupled to the u-shaped hand grip and a finger grip coupled to a lower end of the mount body and at least partially spaced apart from an exterior surface of the seat shell to provide a finger-receiving space therebetween to aid the caregiver in carrying the infant carrier using the woven holding technique;

FIG. 15 is a perspective view of the first handle mount of the infant carrier of FIG. 13;

FIG. 16 is a front plan view showing the caregiver’s hand gripping the first handle mount and fingers of the caregiver extending into the finger-receiving space to engage with a finger-receiving surface of the finger grip; and

FIG. 17 is a perspective view showing a portion of a third embodiment of a carry handing having a finger grip with a plurality of ribs.

### DETAILED DESCRIPTION

An infant carrier 10 includes a seat shell 12 formed to include a child-receiving space 14 configured to hold a child and a carry handle 16 coupled to an exterior surface 18 of the seat shell 12 outside of the child-receiving space 14. The seat shell 12 is configured to be attached to a seat base 11 installed on a vehicle seat 13 in a vehicle or attached directly to the vehicle seat 13. The infant carrier 10 is separable from the seat base 11 and the vehicle seat 13 so that a caregiver can carry the infant carrier 10 away from the vehicle while holding the child in the child receiving space 14.

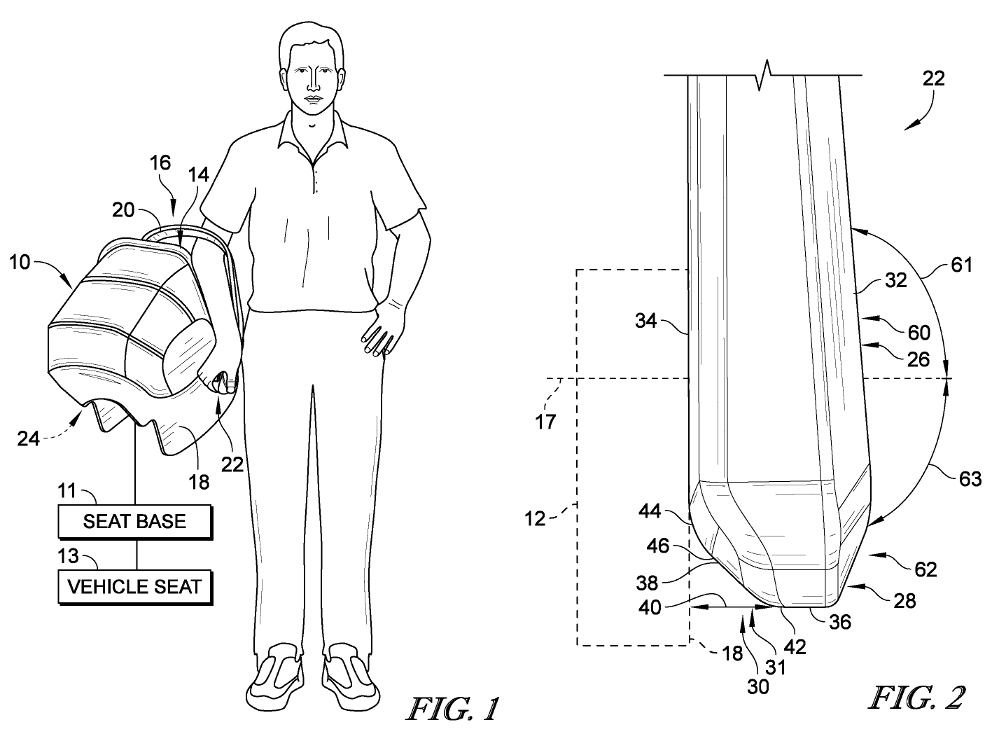

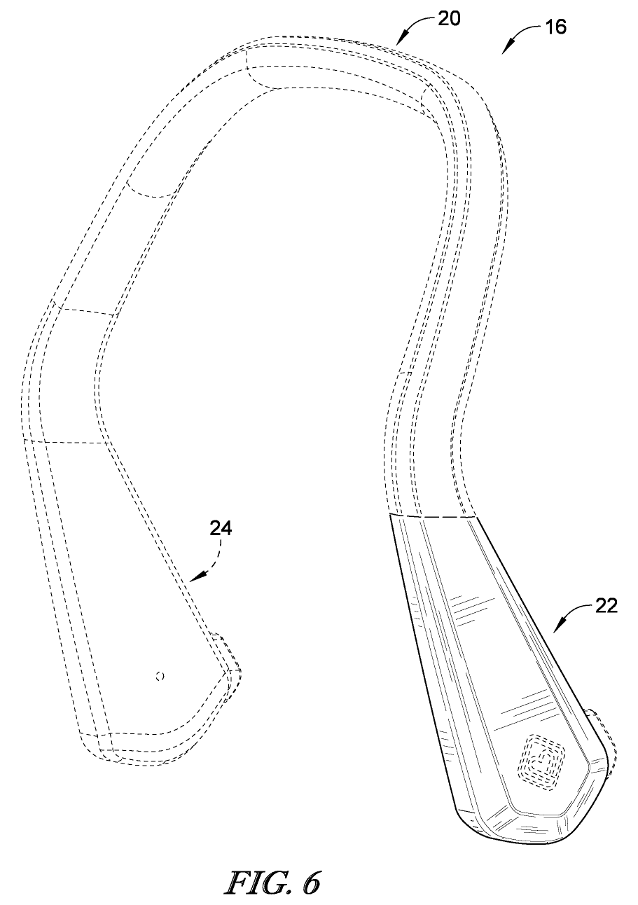

The carry handle 16 is mounted to the seat shell 12 for pivotable movement about a pivot axis 17 and includes a u-shaped hand grip 20, a first handle mount 22, and a second handle mount 24 as shown in FIGS. 1 and 6. The u-shaped hand grip 20 is arranged to extend over the child-receiving space 14 and is adapted to be engaged by a caregiver to carry the infant carrier 10. The first handle mount 22 is coupled to the exterior surface 18 of the seat shell 12 on a first lateral side of the seat shell 12. The second handle mount 24 is coupled to the exterior surface 18 of the seat shell 12 on an opposite second lateral side of the seat shell 12. A caregiver can carry the infant carrier 10 by the u-shaped hand grip 20 in a hanging position or by routing their arm under the u-shaped hand grip 20 and around one of the handle mounts 22, 24 until their hand rests and grips one of the handle mounts 22, 24 in a woven carrying position as shown in FIG. 1.

The first and second handle mounts 22, 24 are substantially similar to one another. Accordingly, only on handle mount 22 is described in detail herein, however, it should be appreciated that the disclosure of handle mount 22 is the same for handle mount 24 aside from handle mount 24 being coupled to an opposite side of the seat shell 12. Each handle mount 22, 24 includes a mount body 26 coupled to the seat shell 12 and a finger grip 28 coupled to a lower end of the mount body 26. The pivot axis 17 extends through a generally central region of the mount body 26. The finger grip 28 is spaced apart from the pivot axis 17 and is configured to pivot about the pivot axis 17 as the carry handle 16 pivots about the pivot axis 17. The mount body 26 is located between the u-shaped hand grip 20 and the finger grip 28 at all orientations of the carry handle 16.

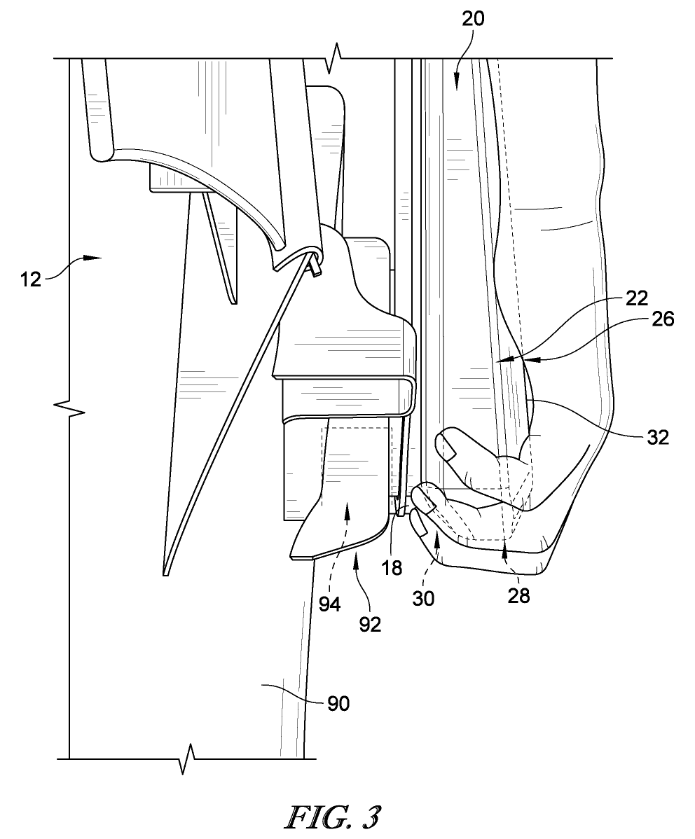

The finger grip 28 is spaced apart from the exterior surface 18 of the seat shell 12 and faces toward the exterior surface 18 of the seat shell 12 as shown in FIGS. 2 and 3. In other words, a finger-receiving space 30 is provided between the finger grip 28 and the exterior surface 18 of the seat shell 12 with sufficient clearance to receive at least fingertips of the caregiver carrying the infant carrier 10 to aid in carrying the infant carrier 10. Other comparative infant carriers minimize space between the handle hubs and the seat shell for aesthetics or to minimize pinch points. In some embodiments, the finger grips 28 may be separate from the mount bodies 26 and attached removably to the mount body 26.

Each handle mount 22, 24 further includes an outward-facing surface 32, an inward-facing surface 34, a downward-facing surface 36, and a finger-receiving surface 38 as shown in FIG. 2. The outward-facing surface 32 faces away from the child-receiving space 14 and the seat shell 12. The inward-facing surface 34 faces toward the child receiving space 14 and interfaces with the exterior surface 18 of the seat shell 12. The downward-facing surface 36 is coupled to a lower end of the outward-facing surface 32 and the finger-receiving surface 38 and faces away from the outward-facing surface 32 and the inward-facing surface 34. The finger-receiving surface 38 is coupled to a lower end of the inward-facing surface 34 and is at least partially spaced apart from the exterior surface 18 of the seat shell 12 to provide the finger-receiving space 30 between the finger-receiving surface 38 and the exterior surface 18 of the seat shell 12. In this way, fingers of the caregiver can be received in the finger-receiving space 30 to engage with the finger-receiving surface 38 while the caregiver is carrying the infant carrier 10.

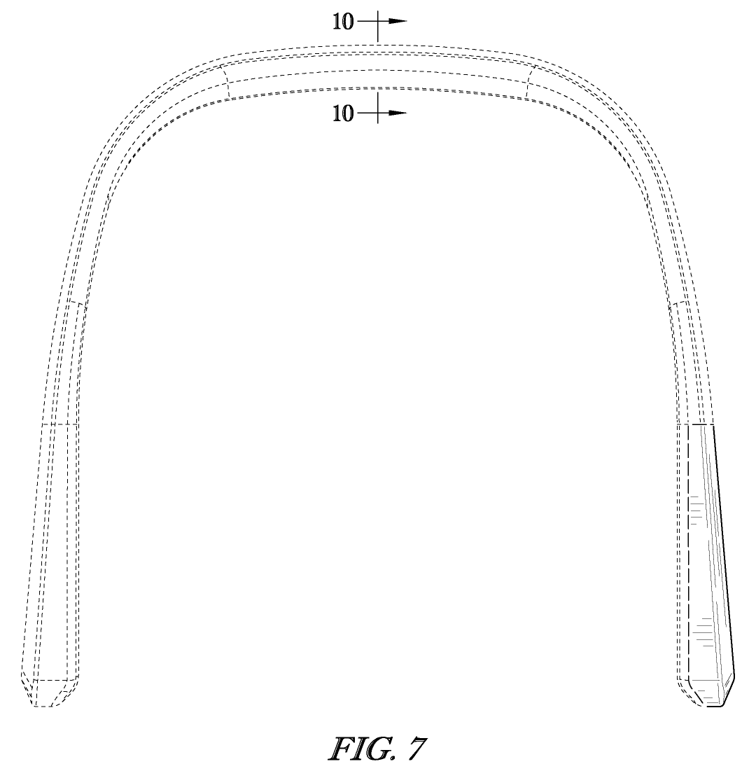

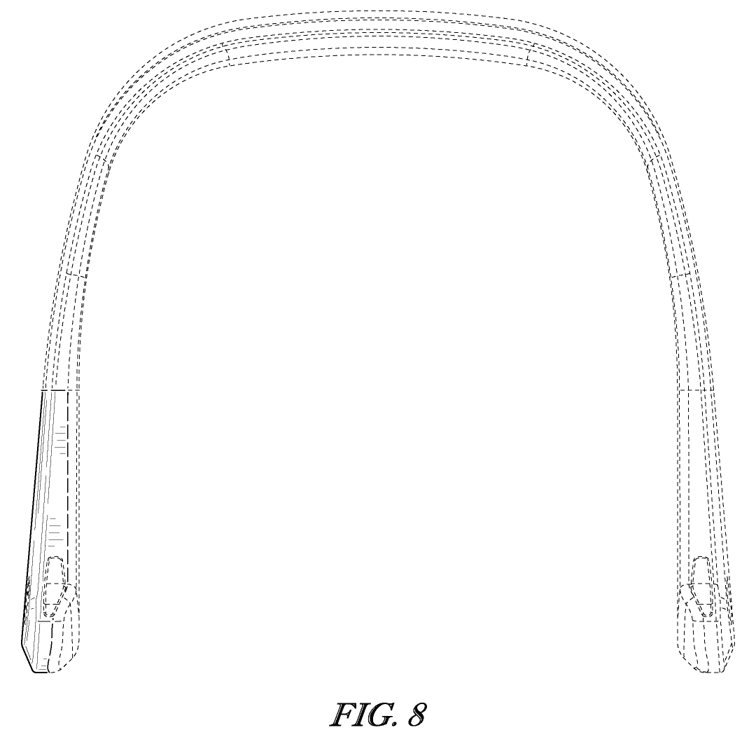

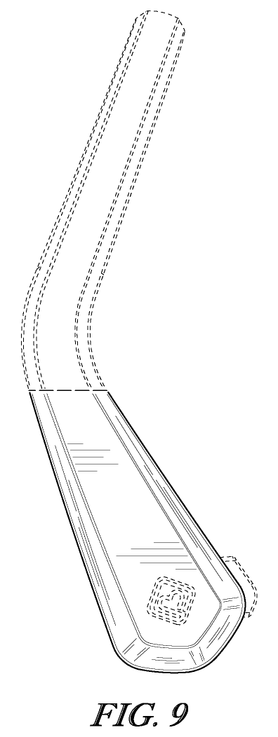

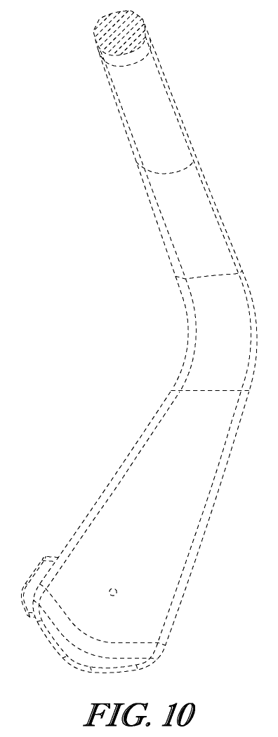

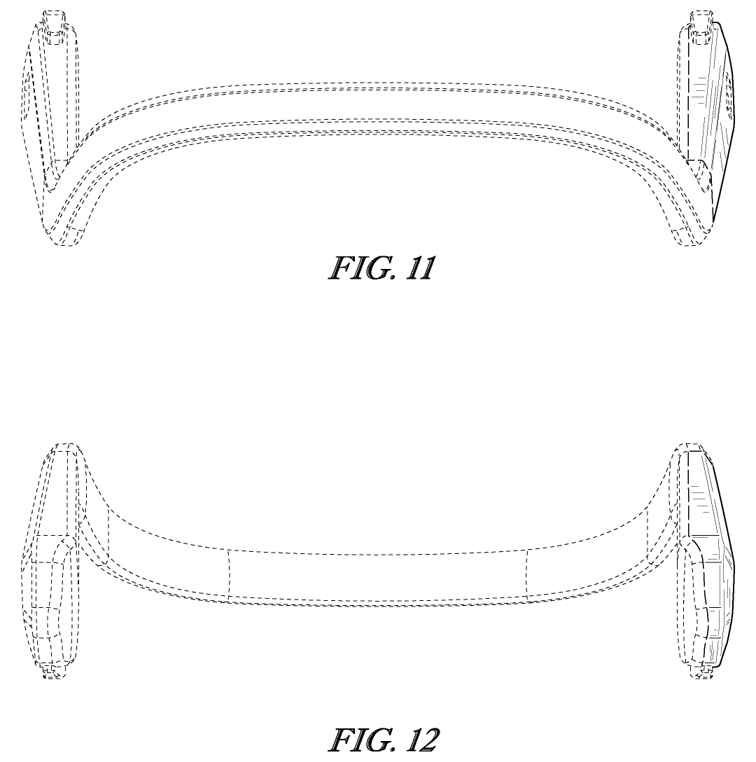

In some embodiments, the finger-receiving space 30 has a depth 40 between the exterior surface 18 of the seat shell 12 and the finger-receiving surface 38 of at least 0.5 inches (1.27 cm). In some embodiments, the depth 40 is at least 0.4 inches (1.016 cm). In some embodiments, the depth 40 is at least 0.3 inches (0.762 cm). In some embodiments, the depth 40 is no more than 1.5 inches (3.81 cm). In some embodiments, the depth 40 is no more than 1.25 inch (3.175 cm). In some embodiments, the depth 40 is no more than 1 inch (2.54 cm). In some embodiments, the depth 40 is no more than 0.9 inch (2.286 cm). In some embodiments, the depth 40 is no more than 0.8 inch (2.032 cm). In some embodiments, the depth 40 is no more than 0.7 inch (1.778 cm). FIGS. 2 and 4-12 show the carry handle, or parts thereof, to scale.

The depth 40 described above occurs at an inlet 31 to the finger-receiving space 30 adjacent to the bottom-facing surface 36 as shown in FIG. 2. The depth 40 decreases as the finger-receiving surface 38 extends toward the inward-facing surface 34. The finger-receiving surface 38 has a first transition surface 42 coupled to the downward-facing surface 36, a second transition surface 44 coupled to the inward-facing surface 34, and a medial surface 46 between the first and second transition surfaces 42, 44. The transition surfaces 42, 44 are convexly shaped. The medial surface 46 is substantially planar or linear, or at least has a greater radius of curvature in comparison to the transition surfaces 42, 44, when viewed from a front end of the infant carrier as shown in FIG. 2. In some embodiments, all or a portion of the finger-receiving surface 38 may be concave relative to the exterior surface 18 of the seat shell 12.

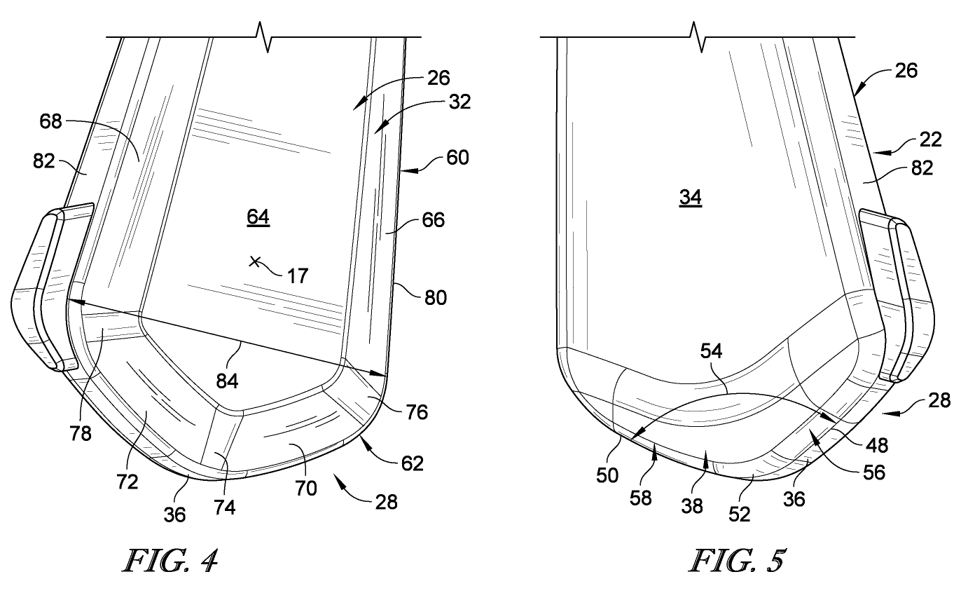

The handle mounts 22, 24 have a geometry that provides an aesthetic and ergonomic handle mount 22, 24 that is more comfortable for a user to grip and handle while carrying the infant carrier 10 in the woven holding position. Each finger grip 28 is generally pointed in a direction facing away from the u-shaped hand grip 20 as shown in FIGS. 4 and 5. When viewed in a direction facing toward the inward-facing surface 36 as shown in FIG. 5, the finger-receiving surface 38 includes a first finger-receiving edge 48 coupled to the bottom-facing surface 36, a second finger-receiving edge 50 coupled to the bottom-facing surface 36, and a tip 52 between the first and second finger-receiving edges 48, 50. The second finger-receiving edge 50 is arranged to extend generally at an angle 54 relative to the first finger-receiving edge 48. The angle 54 is obtuse in the illustrative embodiment. This arrangement provides two finger-receiving regions 56, 58 to make gripping the finger-receiving surface 38 more comfortable irrespective of which side of the finger grip 28 a user’s hand is located. In some embodiments, distinct regions 56, 58 and tip 52 are omitted or less conspicuous than illustrated. In other words, the finger-receiving surface 38 may be a continuous arc having no distinct regions 56, 58 or a tip 52. In the illustrative embodiment, at least a portion of the finger-receiving surface 38 is arcuate.

The outward-facing surface 32 includes an upper segment 60 coupled to the u-shaped hand grip 20 and a lower segment 62 coupled to the downward-facing surface 36 as shown in FIGS. 2 and 4. The upper segment 60 extends at an inclined angle 61 away from the lower segment 62 and toward the child-receiving space 14. The lower segment 62 extends at a declined angle 63 away from the upper segment 60 and toward the child receiving space 14. The inclined angle 61 and the declined angle 63 are both obtuse to the pivot axis 17 when measured in a direction away from child-receiving space 14. This provides a more comfortable resting surface for the caregiver’s palm on the upper segment 60 and a more comfortable resting surface for the caregiver’s knuckles/lower finger areas on the lower segment 62 when gripping the handle mount 22, 24 in comparison to handle mounts that do not have segments at such angles.

The inclined angle 61 is within a range of about 91 degrees to about 120 degrees. The declined angle 63 is within a range of about 100 degrees to about 130 degrees. In the illustrative embodiment, the inclined angle 61 is about 95 degrees and the declined angle is about 110 degrees. The term about means within 3 degrees of the stated value.

The upper segment 60 includes a central panel 64 arranged at the inclined angle 61, an upper front panel 66, and an upper rear panel 68 as shown in FIG. 4. The upper front panel 66 is coupled to a front end of the central panel 64 and an upper end of the lower segment 62. The upper rear panel 68 is coupled to a rear end of the central panel 64 and the upper end of the lower segment 62. The upper front panel 66 and the upper rear panel 68 are non-planar with the central panel 64.

The lower segment 62 includes a lower front panel 70, a lower rear panel 72, and a central transition panel 74 as shown in FIG. 4. The lower front panel 70 is coupled to a lower end of the central panel 64. The lower rear panel 72 is coupled to the lower end of the central panel 64. The central transition panel 74 is coupled to the lower end of the central panel 66 and extends between and interconnecting the lower front panel 70 and the lower rear panel 72. A midpoint of the central transition panel 74 is arranged at the declined angle 63. The lower segment 62 further includes a front transition panel 76 interconnecting a lower end of the upper front panel 66 and the lower front panel 70 and a rear transition panel 78 interconnecting a lower end of the upper rear panel 68 and the lower rear panel 72.

The handle mounts 22, 24 are faceted such that each of the panels 64, 66, 68, 70, and 72 are substantially planar and connected to adjacent panels by one or more arcuate transition panels. The term substantially is used to account for minor arcs that may occur in such panels as a result of the manufacturing process of the handle 16, such as an injection molding process. In other embodiments, such as handle 216 described below, the handle mount may not be faceted and, instead, each surface thereof may be rounded and transition more seamlessly.

The first and second handle mounts 22, 24 each further include a front segment 80 coupled to a front end of the upper front panel 66 and a front end of the downward-facing surface 36 and a rear segment 82 coupled to a rear end of the upper rear panel 68 and a rear end of the downward-facing surface 36 as shown in FIG. 4. The front segment 80 and the rear segment 82 increase in distance from one another from the u-shaped hand grip 20 to a largest width 84. The pivot axis 17 is located between the largest width 84 and the u-shaped hand grip 20 so that the handle mounts 22, 24 are wider at their lower end below the pivot axis 17 compared to above the pivot axis 17 to provide a more comfortable hand/finger seat for the caregiver.

In some embodiments, the seat shell 12 includes a basin 90 formed to include the child-receiving space 14 and first and second handle standoffs 92 coupled to each respective handle mount 22, 24 as shown in FIG. 3. In this instance, the exterior surface 18 includes a portion of the handle standoff 92 closest to the handle mounts 22, 24. The handle standoffs 92 may be formed to include an adaptor receiving space 94 configured to receive an adaptor (not shown) to mount the infant carrier 10 to a stroller, for example.

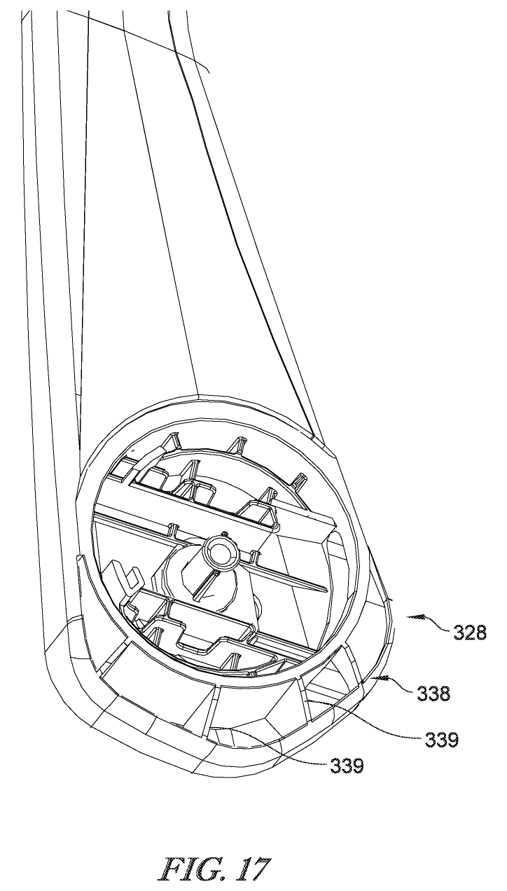

The finger-receiving surface 38 includes one or more continuous segments or portions to provide a smooth surface for the caregiver to grip. In another embodiment, a finger grip 328 for the handle mounts includes a finger-receiving surface 338 provided at least partially by a plurality of ribs 339 that reinforce the finger grip 328 as shown in FIG. 17. Spaces are provided between the ribs 339 and each of the ribs 339 extend in a direction parallel with the pivot axis 17. It is noted that apart from the finger grip 328, the rest of the carry handle is the same as described for carry handle 16.

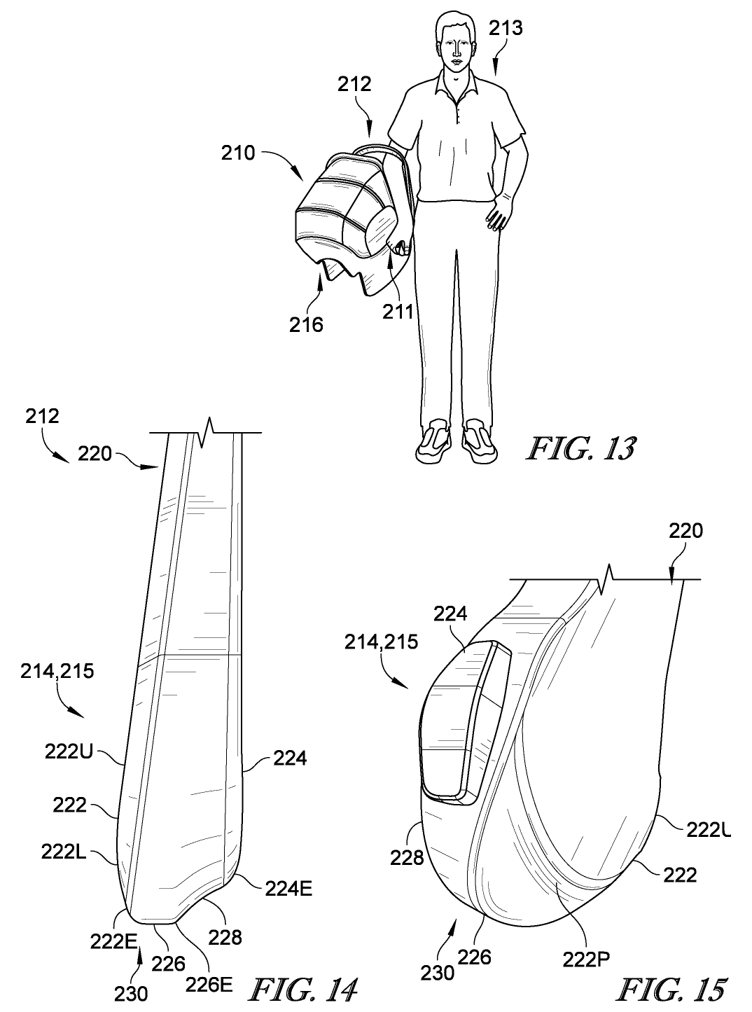

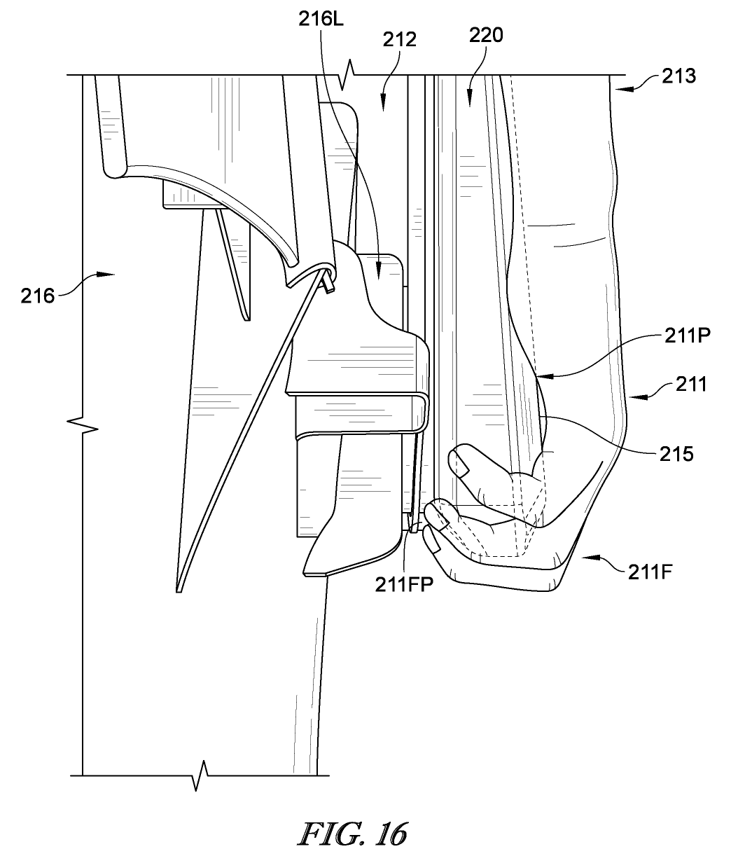

An infant carrier 210 in accordance with the present disclosure includes a carry handle 212 contoured to provide a hand grip 214, 215 to be held with the hand 211 of a caregiver 213 carrying the infant carrier 210 using a woven carrying technique as suggested in FIG. 13. An illustrative embodiment of the carry handle 212 is shown in FIGS. 13-16.

The infant carrier 210 includes a shell 216 and the carry handle 212 as suggested in FIG. 13. The shell 216 is formed to include a basin 218 sized to hold an infant (not shown). The carry handle 212 is coupled to the shell 216 as suggested in FIGS. 13-16.

The carry handle 212 includes a first hand grip 214 coupled to one side 216R of the shell 216, a second hand grip 215 coupled to another side 216L of the shell 211, and a bridge rail 220 as suggested in FIGS. 13-16. The bridge rail 220 is arranged to interconnect first and second side hand grips 214, 215 and lie above basin 213 as suggested in FIGS. 13-16.

The firsthand grip 214 and the secondhand grip 215 each include an outward-facing surface 222, an inward facing surface 224, a downward-facing surface 226, and a grip-receiving surface 228. The outward-facing surface 222 and the inward-facing surface 224 extend downwardly from the bridge rail 220 towards a grip end 230 of the hand grip 214. The downward-facing surface 226 is coupled to a lower end 222E of the outward-facing surface 222 and is spaced apart from a lower end 224E of the inward-facing surface 224. The grip-receiving surface 228 extends between and interconnects an inner end 226E of the downward-facing surface 226 and the lower end 224E of the inward-facing surface 224. The inward-facing surface 224 engages and faces the respective side 216R, 216L of the shell 216.

The outward-facing surface 222 includes an upper segment 222U that slopes gradually outward from the bridge rail 220 and a lower segment 222L that slopes gradually inward from the upper segment 222U to the downward-facing surface 26. Accordingly, the outward-facing surface 222 provides a convex surface for engagement with a palm 211P of a caregiver 213 carrying the infant carrier 210 using a woven carrying technique as suggested in FIGS. 13-16.

The grip-receiving surface 228 extends upwardly and defines a concave curve between the downward-facing surface 226 and the lower end 224E of the inward-facing surface 224. Accordingly, when a caregiver 213 is carrying the infant carrier 210 using a woven carrying technique, the caregiver 213 engages their palm 211P with the outward-facing surface 222 and wraps their fingers 211F under the downward-facing surface 226 to engage their finger pads 211FP with the grip-receiving surface 228. In some embodiments, the grip-receiving surface 228 may be straight and extend between the downward-facing surface 226 and the lower end 224E of the inward-facing surface 224. Alternatively, or additionally, one or more of the grip-receiving surface 228, the downward-facing surface 226, and the outward-facing surface 222 may be formed to include or have coupled to the respective surface 228, 226, 222 a roughened surface (i.e., a plurality of raised bumps) to provide friction between the caregiver’s hand 211 and the respective surface 228, 226, 222. The first and secondhand grips 214, 215 are configured to provide comfort to a caregiver 213 that is carrying the infant carrier 210 using a woven carrying technique.

1. An infant carrier comprising
a seat shell formed to include a child-receiving space configured to hold a child and
a carry handle coupled to an exterior surface of the seat shell outside of the child-receiving space, the carry handle including a u-shaped hand grip arranged to extend over the child-receiving space and adapted to be engaged by a caregiver to carry the infant carrier, a first handle mount coupled to the exterior surface on a first lateral side of the seat shell, and a second handle mount coupled to the exterior surface on an opposite, second lateral side of the seat shell,
wherein the first handle mount and the second handle mount each include an outward-facing surface facing away from the child-receiving space, an inward-facing surface facing toward the child receiving space and interfacing with the exterior surface of the seat shell, a downward-facing surface coupled to a lower end of the outward-facing surface and facing away from the outward-facing surface and the inward-facing surface, and a finger-receiving surface coupled to a lower end of the inward-facing surface and spaced apart from the exterior surface of the seat shell to provide a finger-receiving space between the finger-receiving surface and the exterior surface of the seat shell so that fingers of the caregiver can be received in the finger-receiving space to engage with the finger-receiving surface while the caregiver is carrying the infant carrier.

2. The infant carrier of claim 1, wherein the finger-receiving space has a depth of at least 0.5 inches (1.27 cm).

3. The infant carrier of claim 2, wherein the depth is at least 0.5 inches (1.27 cm) at an inlet to the ringer-receiving space adjacent to the bottom-facing surface, and the depth decreases toward the inward-facing surface.

4. The infant carrier of claim 3, wherein the finger-receiving surface is concave relative to the exterior surface of the seat shell.

5. The infant carrier of claim 1, wherein the finger-receiving surface includes a first finger-receiving edge coupled to the bottom-facing surface and a second finger-receiving edge coupled to the bottom-facing surface and arranged to extend generally at an angle relative to the first finger-receiving edge to provide the finger-receiving surface and the bottom-facing surface with a tip between the first finger-receiving edge and the second finger-receiving edge.

6. The infant carrier of claim 1, wherein the outward-facing surface includes an upper segment coupled to the u-shaped hand grip and a lower segment coupled to the downward-facing surface, the upper segment extending at an inclined angle away from the lower segment and toward the child-receiving space, and the lower segment extending at a declined angle away from the upper segment and toward the child receiving space.

7. The infant carrier of claim 6, wherein the carry handle is configured to pivot relative to the seat shell about a pivot axis, and the inclined angle is within a range of about 95 degrees to about 115 degrees when measured in a first direction from the pivot axis.

8. The infant carrier of claim 7, wherein the declined angle is within a range of about 100 degrees to about 130 degrees when measured in a second direction from the pivot axis opposite the first direction.

9. The infant carrier of claim 6, wherein the upper segment includes a central panel arranged at the inclined angle, an upper front panel coupled to a front end of the central panel and an upper end of the lower segment, and an upper rear panel coupled to a rear end of the central panel and an upper end of the lower segment, and wherein the upper front panel and the upper rear panel are non-planar with the central panel.

10. The infant carrier of claim 9, wherein the lower segment includes a lower front panel coupled to a lower end of the upper front panel and a lower end of the central panel, a lower rear panel coupled to a lower end of the upper rear panel and the lower end of the central panel, and a central transition panel coupled to the lower end of the central panel and extending between and interconnecting the lower front panel and the lower rear panel, and wherein a midpoint of the central transition panel is arranged at the declined angle.

11. The infant carrier of claim 10, wherein the first and second handle mounts each further include a front segment coupled to a front end of the upper front panel and a front end of the downward-facing surface and a rear segment coupled to a rear end of the upper rear panel and a rear end of the downward-facing surface, and wherein the front segment and the rear segment increase in distance from one another from the u-shaped hand grip to a largest width, and the pivot axis is located between the largest width and the u-shaped hand grip.

12. An infant carrier comprising
a seat shell formed to include a child-receiving space configured to hold a child and
a carry handle coupled to an exterior surface of the seat shell outside of the child-receiving space, the carry handle including a u-shaped hand grip arranged to extend over the child-receiving space and adapted to be engaged by a caregiver to carry the infant carrier, a first handle mount coupled to the exterior surface on a first lateral side of the seat shell, and a second handle mount coupled to the exterior surface on an opposite second lateral side of the seat shell,
wherein the first and second handle mounts each include a mount body coupled to the seat shell for pivotable movement about a pivot axis and a finger grip coupled to a lower end of the mount body and facing toward the exterior surface of the seat shell, the finger grip being spaced apart from the exterior surface of the seat shell and configured to receive fingertips of a user to aid in carrying the infant carrier.

13. The infant carrier of claim 12, wherein each finger grip is spaced from the exterior surface of the seat shell by a distance of at least 0.5 inches (1.27 cm).

14. The infant carrier of claim 13, wherein the distance is at least 0.5 inches (1.27 cm) at a lower end of the finger grip, and the distance decreases toward the pivot axis.

15. The infant carrier of claim 12, wherein each finger grip includes a first lower edge and a second lower edge arranged to extend generally at an angle relative to the first lower edge to provide the finger grip with a tip between the first lower edge and the second lower edge.

16. The infant carrier of claim 12, wherein the first handle mount and the second handle mount each include an outward-facing surface facing away from the child-receiving space, an inward-facing surface facing toward the child receiving space and interfacing with the exterior surface of the seat shell, a downward-facing surface coupled to a lower end of the outward-facing surface and facing away from the outward-facing surface and the inward-facing surface, and a finger-receiving surface coupled to a lower end of the inward-facing surface and spaced apart from the exterior surface of the seat shell to provide a finger-receiving space between the finger-receiving surface and the exterior surface of the seat shell so that fingers of the caregiver can be received in the finger-receiving space to engage with the finger-receiving surface while the caregiver is carrying the infant carrier.

17. The infant carrier of claim 16, wherein the outward-facing surface includes an upper segment coupled to the u-shaped hand grip and a lower segment coupled to the downward-facing surface, the upper segment extending at an inclined angle away from the lower segment and toward the child-receiving space, and the lower segment extending at a declined angle away from the upper segment and toward the child receiving space.

18. The infant carrier of claim 17, wherein the carry handle is configured to pivot relative to the seat shell about a pivot axis, and the inclined angle is within a range of about 95 degrees to about 120 degrees when measured in a first direction from the pivot axis.

19. The infant carrier of claim 18, wherein the declined angle is within a range of about 95 degrees to about 120 degrees when measured in a second direction from the pivot axis opposite the first direction.

20. The infant carrier of claim 17, wherein the upper segment includes a central panel arranged at the inclined angle, an upper front panel coupled to a front end of the central panel and an upper end of the lower segment, and an upper rear panel coupled to a rear end of the central panel and an upper end of the lower segment, and wherein the upper front panel and the upper rear panel are non-planar with the central panel.
